(19) United States
(12) Patent Application Publication
(10) Pub. No.: US 2008/0104020 A1
(43) Pub. Date: May 1, 2008

(54) Handwritten Query Builder

(75) Inventor: Koji Kato, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/553,954

(22) Filed: Oct. 27, 2006

(51) Int. Cl. G06F 17/30

(52) U.S. Cl. 707/3

(57) ABSTRACT

Implementations of a handwritten query builder are described. Digital ink objects entered by a user are interpreted to generate multiple search terms. The search terms are ordered based on relationships between the digital ink objects to create a query string. For example, relative position (vertical and/or horizontal), relative height, relative line thickness, relative line color, and so on, may be used independently or in combination to determine an ordering of the search terms represented by the digital ink objects.

### BACKGROUND

Building queries for interact search engines can be a tedious process. For example, two queries built from the same keywords, but with the keywords arranged in difference sequences can result in two different result sets. Often times, a user will enter several keywords as a search string, but the returned results are not what the user expected. The user may then rearrange the order of the keywords in the search string in an attempt to retrieve more expected results.

Pen-controlled computing devices, such as Personal Digital Assistants (PDAs) and tablet computers, are finding increased commercial relevance. Such devices typically replace or supplement a traditional mouse and keyboard with a pen that serves both as a pointing device and as a device for entering “digital ink”. With such pen-controlled computing devices, creation and modification of search strings can be a tedious task.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A handwritten query builder is described. A user enters search terms as digital ink objects. The digital ink objects are converted to text and arranged to form a query string. The order of the search terms in the query string is determined based on relative positions of the digital ink objects. For example, relative vertical positions of the digital ink objects may be used to determine the ordering with the first search term in the query string corresponding the digital ink object having the highest vertical position. Other relative characteristics may also be used to determine the order of the terms in the query string. Example characteristics may include, but are not limited to, relative vertical position, relative horizontal position, relative height, relative line thickness, relative color, etc. A user may also easily change the order of terms in a query string by re-arranging the digital ink objects. For example, moving a digital ink object to a lower screen position may move the search term associated with the digital ink object to a position further to the right in the query string.

### BRIEF DESCRIPTION OF THE DRAWINGS

FIG. 1 illustrates generation of a search string by an exemplary handwritten query builder based on relative vertical positions of digital ink objects.

FIG. 2 illustrates generation of a search string by an exemplary handwritten query builder based on relative horizontal positions of digital ink objects.

FIG. 3 illustrates generation of a search string by an exemplary handwritten query builder based on relative heights of digital ink objects.

FIG. 4 illustrates modification of a search string using an exemplary handwritten query builder based on relative positions of digital ink objects.

FIG. 5 illustrates generation, by an exemplary handwritten query builder, of a search string that includes an OR command.

FIG. 6 illustrates creation of a search string using an exemplary handwritten query builder based on digital ink objects.

FIG. 7 illustrates creation of a search string and search filter using an exemplary handwritten query builder based on digital ink objects.

FIG. 8 illustrates creation of a search string and search filter using an exemplary handwritten query builder based on digital ink objects and an image.

FIG. 9 illustrates an exemplary environment 900 in which a handwritten query builder may be implemented.

FIG. 10 illustrates select components of an exemplary computing device implementing a handwritten query builder.

FIG. 11 illustrates an exemplary method for implementing a handwritten query builder.

### DETAILED DESCRIPTION

The embodiments of an exemplary handwritten query builder described below provide techniques for generating a query string based on handwritten input and for determining a keyword sequence of the query string based on a two-dimensional layout of the handwritten input. Handwritten input may include, for example, handwritten text and/or handwritten drawings. In an exemplary implementation, each handwritten entity is referred to as a digital ink object. If the digital ink object is a handwritten word or phrase, then that word or phrase is added to a query string. If the digital ink object is a handwritten drawing, then the drawing may be interpreted as a word or phrase that represents the drawing (e.g. a drawing of a star may be interpreted as the word, “star”). Alternatively, the handwritten drawing may be interpreted as a command to limit the search to images. Furthermore, a handwritten drawing may be interpreted as a combination of text and a command. For example, a handwritten drawing of a person wearing blue pants and a yellow shirt may be interpreted as a command to search for images that include a person wearing blue pants and a yellow shirt.

In addition to determining search commands and keywords based on the handwritten input, an exemplary handwritten query builder also determines an ordering of the determined keywords in the generated query string. In an exemplary implementation, the ordering of the determined keywords is based on a two-dimensional arrangement of the digital ink objects. As such, a user can rearrange the order of keywords in a query string by simply moving one or more of the digital ink objects to a different location in relation to one or more other digital ink objects. In an exemplary implementation, vertical and/or horizontal relationships between the digital ink objects are used to determine the sequence of the keywords in a generated query string. In an alternate implementation, other characteristics may also be used to determine the sequence of the keywords in the generated query string. Such other characteristics may include, but are not limited to, ink color, line thickness, and object size.

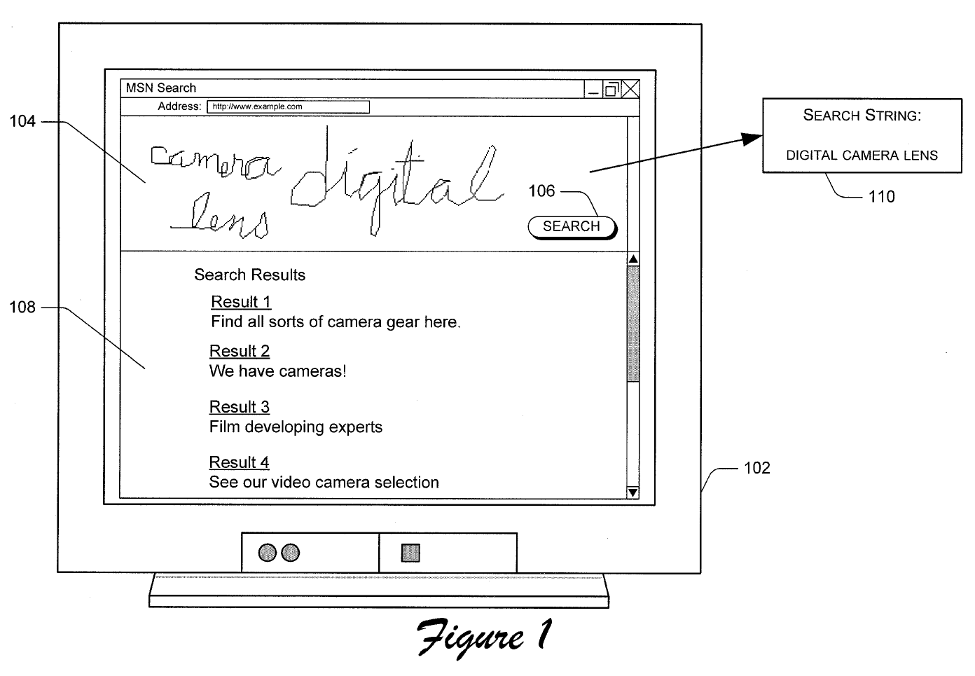

FIG. 1 illustrates generation of a search string by an exemplary handwritten query builder based on relative vertical positions of digital ink objects. Display device 102 provides a means by which a user can enter digital ink objects. In the illustrated example, a web browser user interface is shown that includes a digital ink input area 104, a search command button 106, and a results area 108. A user enters one or more digital ink objects and selects the search button. The handwritten query builder generates a search string for the web browser based on the digital ink objects. For example, as shown in FIG. 1, the user has entered three digital ink objects, each representing a word (i.e., “camera”, “digital”, and “lens”). The handwritten query builder converts the digital ink object to text, and orders the words in a search string 110 based on the relative vertical positions of the digital ink objects. The search string is then submitted to the web browser, which performs a search and returns results in results area 108. In the illustrated example, the relative vertical positions of the digital ink objects are determined based on the top-most point of each object. Alternate implementations may determine the relative vertical positions based on the bottom most point of each object, the vertical midpoint of each object, or the center of ink density of each object. The center of ink density of a digital ink object can be calculated, for example, by averaging the ink data points of the object. In other words, digital ink is a collection of data points that are submitted at a certain rate. For example in a Tablet PC, ink injection occurs at 133 hz, namely 133 data points per second. These data points form the digital ink. By averaging the (x,y) coordinate locations of the ink data points for a particular digital ink object, a weighted center of ink density can be determined. That is, for a particular object, the center of ink density (x,y) can be calculated as (x,y)=((SUM(X)/(number of data points), SUM(Y)/(number of data points)).

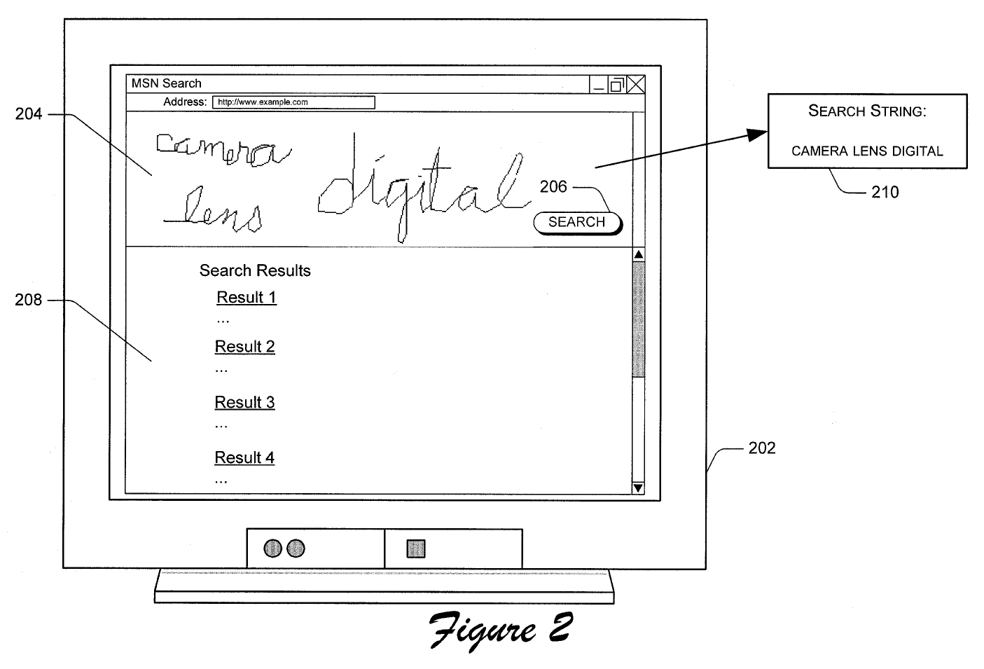

FIG. 2 illustrates generation of a search string by an exemplary handwritten query builder based on relative horizontal positions of digital ink objects. Display device 202 provides a means by which a user can enter digital ink objects. In the illustrated example, a web browser user interface is shown that includes a digital ink input area 204, a search command button 206, and a results area 208. A user enters one or more digital ink objects and selects the search button. The handwritten query builder generates a search string for the web browser based on the digital ink objects. For example, as shown in FIG. 2, the user has entered three digital ink objects, each representing a word (i.e., “camera”, “digital”, and “lens”). The handwritten query builder converts the digital ink object to text, and orders the words in a search string 210 based on the relative horizontal positions of the digital ink objects. The search string is then submitted to the web browser, which performs a search and returns results in results area 208. In the illustrated example, the relative horizontal positions of the digital ink objects are determined based on the left-most point of each object. Alternate implementations may determine the relative horizontal positions based on the right-most point of each object, the horizontal midpoint of each object, or the center of ink density of each object.

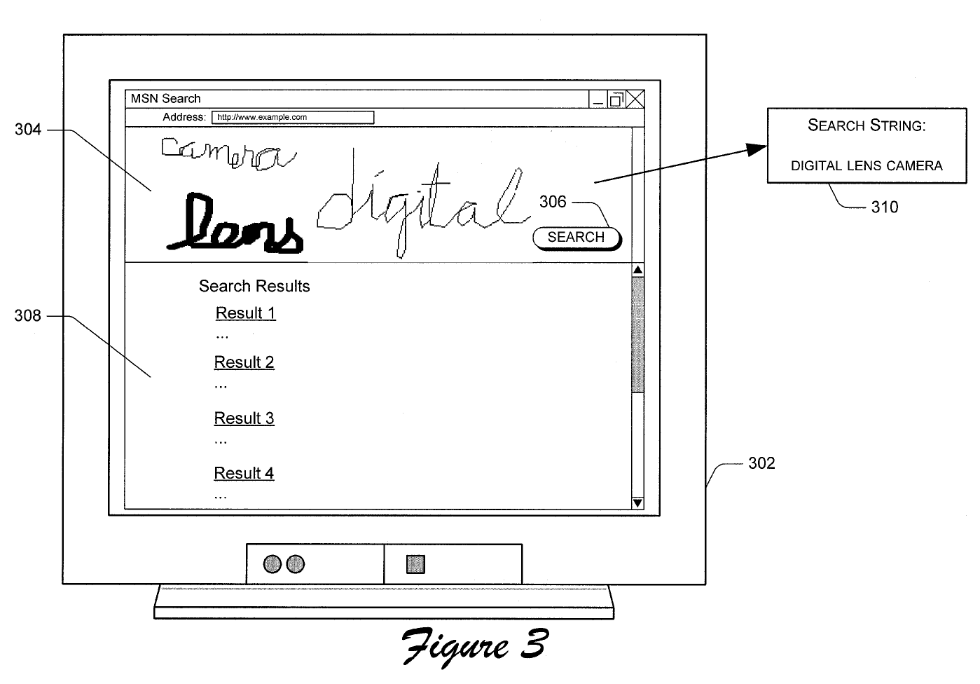

FIG. 3 illustrates generation of a search string by an exemplary handwritten query builder based on relative heights of digital ink objects. Display device 302 provides a means by which a user can enter digital ink objects. In the illustrated example, a web browser user interface is shown that includes a digital ink input area 304, a search command button 306, and a results area 308. A user enters one or more digital ink objects and selects the search button. The handwritten query builder generates a search string for the web browser based on the digital ink objects. For example, as shown in FIG. 3, the user has entered three digital ink objects, each representing a word (i.e., “camera”, “digital”, and “lens”). The handwritten query builder converts the digital ink object to text, and orders the words in a search string 310 based on the relative heights of the digital ink objects. The search string is then submitted to the web browser, which performs a search and returns results in results area 308. In an alternate implementation, the order of the terms in the search string may be based, at least in part, on line thickness and/or ink color. For example, in the example shown in FIG. 3, the generated query string may be “lens camera digital” if the order is determined based on line thickness and relative horizontal positions.

In an exemplary implementation, any combination of relative characteristics may be used to determine the order of terms in a query string. As described above, such characteristics may include, but are not limited to, relative horizontal position, relative vertical position, relative height, relative line thickness, relative line color, and so on. For example, if the search string is generated based on the relative vertical positions of the digital ink objects and two of the objects are determined to have the same vertical position, then the order of the two digital ink objects may be determined based on relative horizontal positions of the two digital ink objects. Similarly, if the search string is generated based on the relative line thickness of the digital ink objects and two of the objects are determined to have the same line thickness, then the order of the two digital ink objects may be determined based on relative vertical positions of the two digital ink objects.

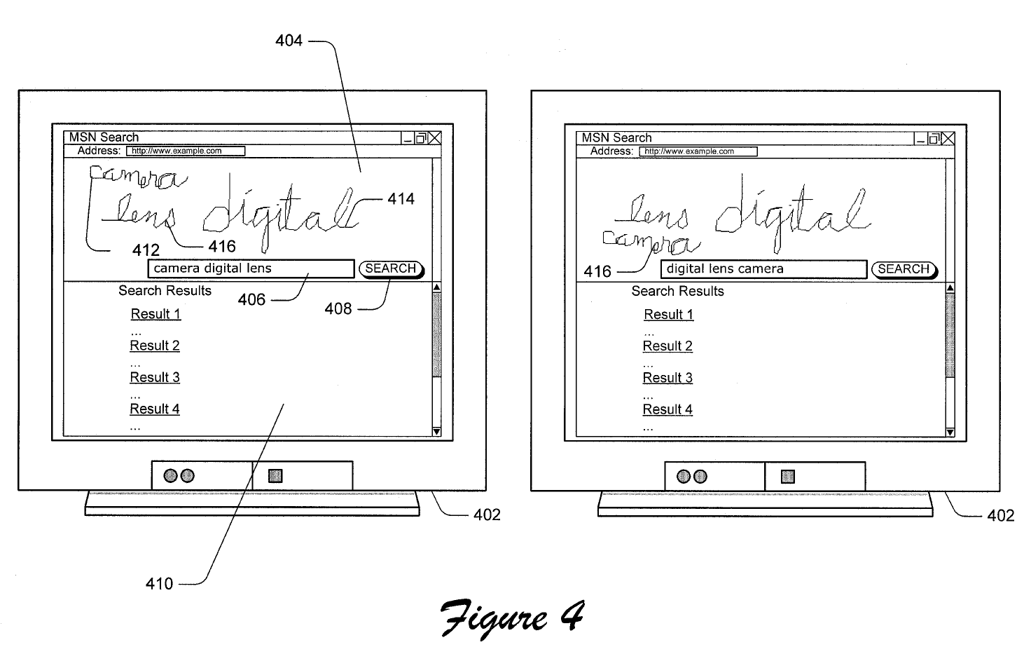

FIG. 4 illustrates modification of a search string using an exemplary handwritten query builder based on relative positions of digital ink objects. Display device 402 provides a means by which a user can enter digital ink objects. In the illustrated example, a web browser user interface is shown that includes a digital ink input area 404, a search string text box 406, a search command button 408, and a results area 410. A user enters one or more digital ink objects 412, 414, and 416. In an exemplary implementation, as the user enters a digital ink object, the digital ink is automatically converted to text and added to the search string in search string text box 406. In the example shown in FIG. 4, based on relative vertical positions, the search string generated is “camera digital lens”. If the user wishes to modify the order of the terms in the generated search string, the user can move one or more of the digital ink objects, thereby modifying their relative positions. For example, by moving digital ink object 412 down to the position indicated by digital ink object 416, the search string is automatically modified to read “digital lens camera”.

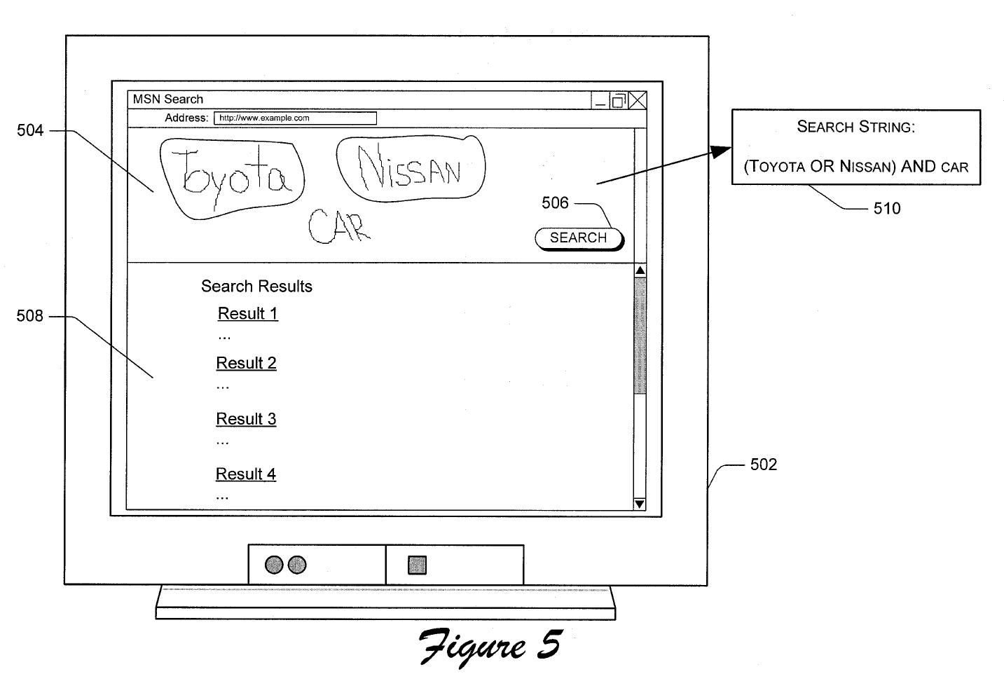

FIG. 5 illustrates generation of a search string by an exemplary handwritten query builder, where the search string includes an OR command. Display device 502 provides a means by which a user can enter digital ink objects. In the illustrated example, a web browser user interface is shown that includes a digital ink input area 504, a search command button 506, and a results area 508. A user enters one or more digital ink objects and selects the search button. The handwritten query builder generates a search string for the web browser based on the digital ink objects. Typically, when a user enters a series of search terms, a search is performed as if there is an AND command between each of the search terms. This may lead to undesirable results. For example, if a user were shopping for a new car and was interested in either a Toyota or a Nissan, common search terms may include “Toyota”, “Nissan”, and “car”. Simply entering those three words, however may lead to undesirable results, in that the query that is run will be of the format, “Toyota AND Nissan AND car”, so only those websites that include all three of the terms will be returned. A more appropriate query may be, “(Toyota OR Nissan) AND car”. An exemplary implementation of a handwritten query builder provides a means for users to specify such groupings of search terms in the query to be generated.

For example, as shown in FIG. 5, the user has entered three digital ink objects, each representing a word (i.e., “Toyota”, “Nissan”, and “car”). The user has also defined a grouping of search terms by encircling both “Toyota” and “Nissan”. As described above, the handwritten query builder converts the digital ink objects to text. Next, any search term groupings are identified, and the terms are ordered to generate search string 510. For example, because two terms are encircled, they are grouped. The order of the terms in the group is determined, for example, based on the relative horizontal positions of the digital ink objects representing the grouped terms. The order of the group(s) and any other terms is determined, for example, based on the relative horizontal positions of each group and term. In the example shown in FIG. 5, the group (“Toyota” “Nissan”) is identified, and the terms are ordered, then the group and the term car are ordered. Finally, the search string 510 is generated with the terms in the group separated by an OR command, and each of the groups and/or single terms are separated by an AND command. The search string is then submitted to the web browser, which performs a search and returns results in results area 508. FIG. 5 illustrates denoting a group by encircling each member of the group. Alternate implementations may provide other means for denoting a group. For example, encircling all of the members of the group together (e.g., putting one circle around both “Toyota” and “Nissan”), or using a different ink color for each group (e.g., “Toyota” and “Nissan” both in red ink, and “car” in black ink). It is recognized that any number of techniques may be implemented to provide a means for grouping two or more terms.

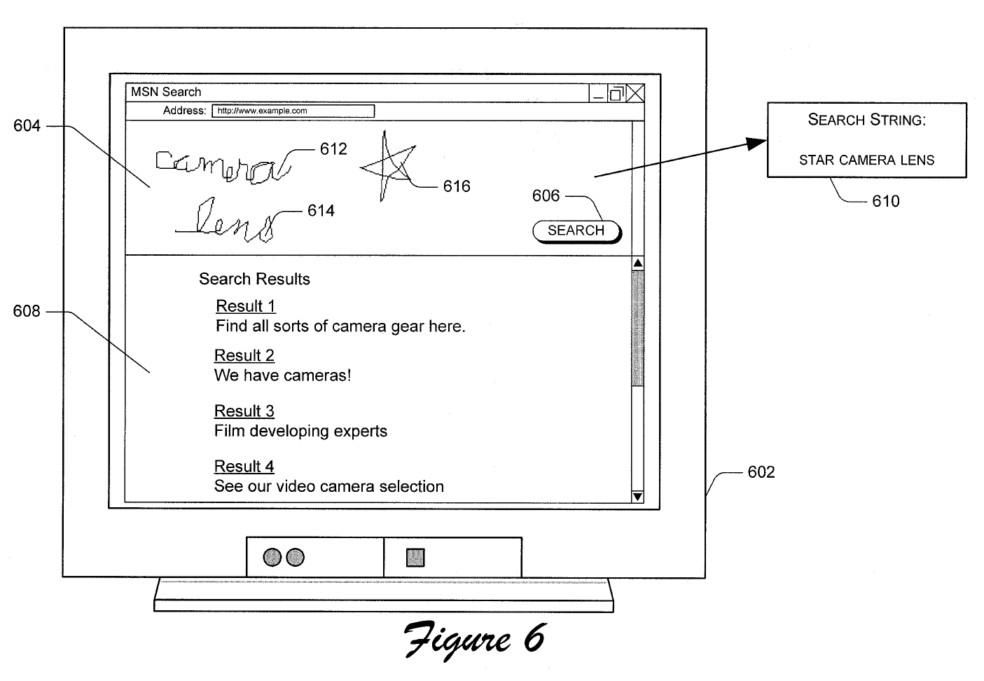

FIG. 6 illustrates creation of a search string using an exemplary handwritten query builder based on digital ink objects. Display device 602 provides a means by which a user can enter digital ink objects. In the illustrated example, a web browser user interface is shown that includes a digital ink input area 604, a search command button 606, and a results area 608. A user enters one or more digital ink objects 612, 614, and 616. In an exemplary implementation, as the user enters a digital ink object, the digital ink is automatically converted to text. For example, digital ink object 612 is converted to “camera” and digital ink object 614 is converted to “lens”. In an exemplary implementation, the handwritten query builder is configured to also convert to text, digital ink objects that represent recognizable shapes. For example, digital ink object 616 is converted to the text “star”. In an exemplary implementation, the handwritten query builder may be configured to recognize any number of shapes and drawings as text, or to apply any number of configurable rules when a drawing is entered as a digital ink object.

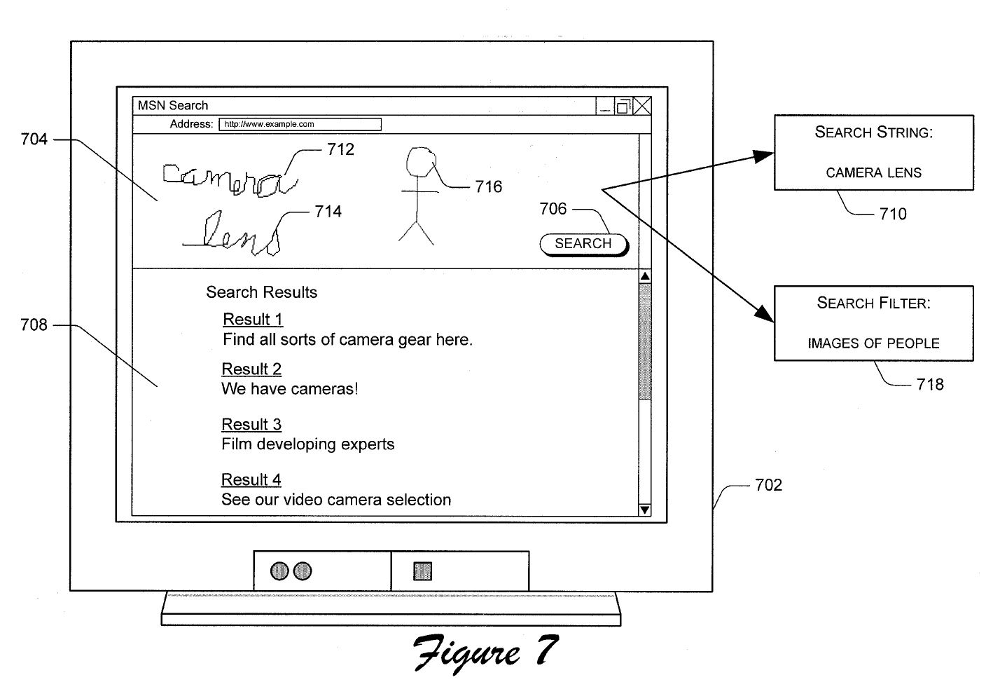

FIG. 7 illustrates creation of a search string and search filter using an exemplary handwritten query builder based on digital ink objects. Display device 702 provides a means by which a user can enter digital ink objects. In the illustrated example, a web browser user interface is shown that includes a digital ink input area 704, a search command button 706, and a results area 708. A user enters one or more digital ink objects 712, 714, and 716. In an exemplary implementation, as the user enters a digital ink object, the digital ink is automatically converted to text. For example, digital ink object 712 is converted to “camera” and digital ink object 714 is converted to “lens”. In an exemplary implementation, the handwritten query builder is configured to create search filters based on digital ink objects that represent recognizable shapes. For example, digital ink object 716 is used to generate a search filter 718 that will limit search results to images of people. In an exemplary implementation, the handwritten query builder may be configured to apply any number of configurable rules when a drawing is entered as a digital ink object, such as convert recognizable shapes and drawings to text, or apply a filtering command based on a recognizable shape or drawing.

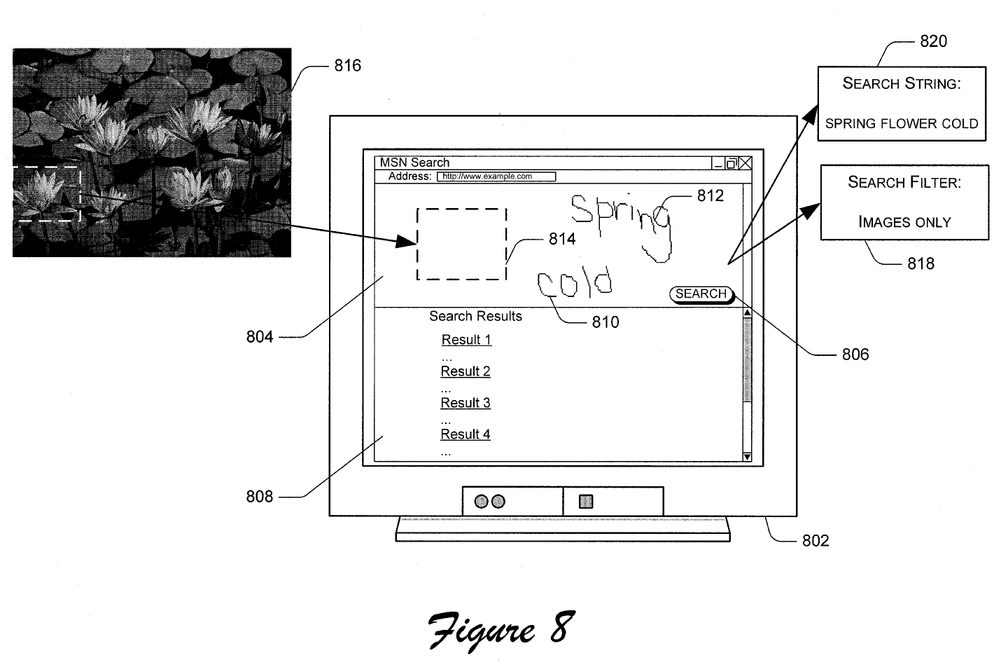

FIG. 8 illustrates creation of a search string and search filter using an exemplary handwritten query builder based on digital ink objects and an image. Display device 802 provides a means by which a user can enter digital ink objects and/or paste images. In the illustrated example, a web browser user interface is shown that includes a digital ink input area 804, a search command button 806, and a results area 808; A user enters one or more digital ink objects 810 and 812, which are automatically converted to text. In the illustrated example, the user also selects and pastes into digital ink input area 804, a portion 814 of an image 816. In an exemplary implementation, the handwritten query builder is configured to generate search terms and/or create search filters based on images pasted into digital ink input area 804. For example, image portion 814 is used to generate a search filter 818 that will limit search results to images. Image portion 814 is also used to generate a search term (i.e., “flower”) that is included in the generated search string 820. In an exemplary implementation, the handwritten query builder may be configured to apply any number of configurable rules when an image is pasted into digital ink input area 804.

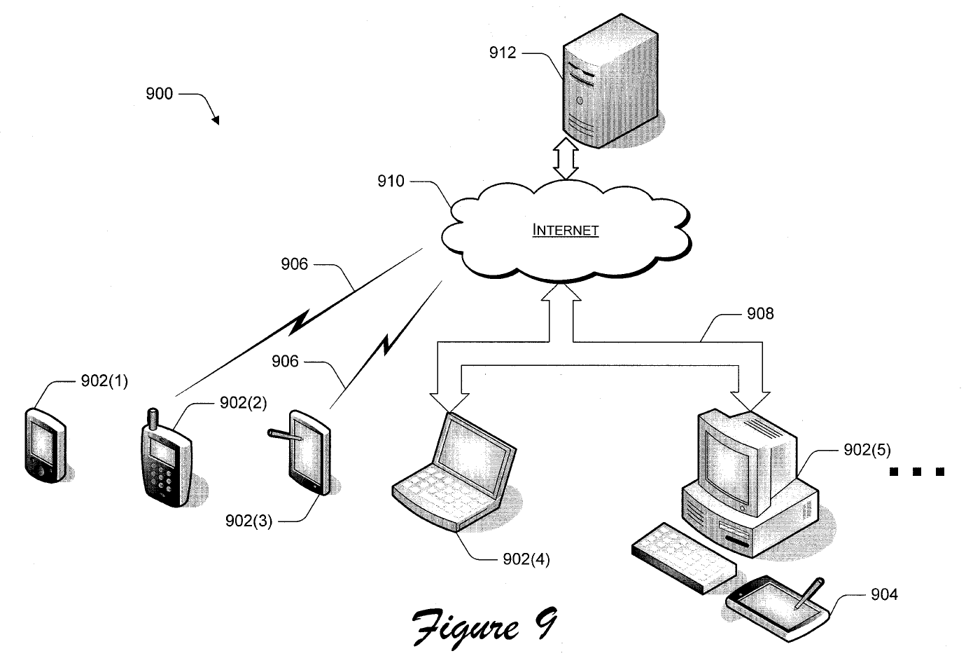

FIG. 9 illustrates an exemplary environment 900 in which a handwritten query builder may be implemented. Exemplary environment 900 includes one or more computing devices 902 such as personal digital assistant (PDA) 902(1), smart phone 902(2), tablet personal computer (PC) 902(3), laptop computer 902(4), and desktop computer 902(5) that includes a tablet interface 904. Computing devices 902 may be standalone devices, wireless networking devices, and/or wired networking devices. For example, in the exemplary environment 900 shown, PDA 902(1) is a standalone device; smart phone 902(2) and tablet PC 902(3) are wireless computing devices that communicate via a wireless network 906; and laptop computer 902(4) and desktop computer 902(5) are wired computing devices that communicate via a local area network 908 and/or a wide area network, such as the Internet 9 10. Network connections may provide one or more of computing devices 902 with access to resources such as web server 912.

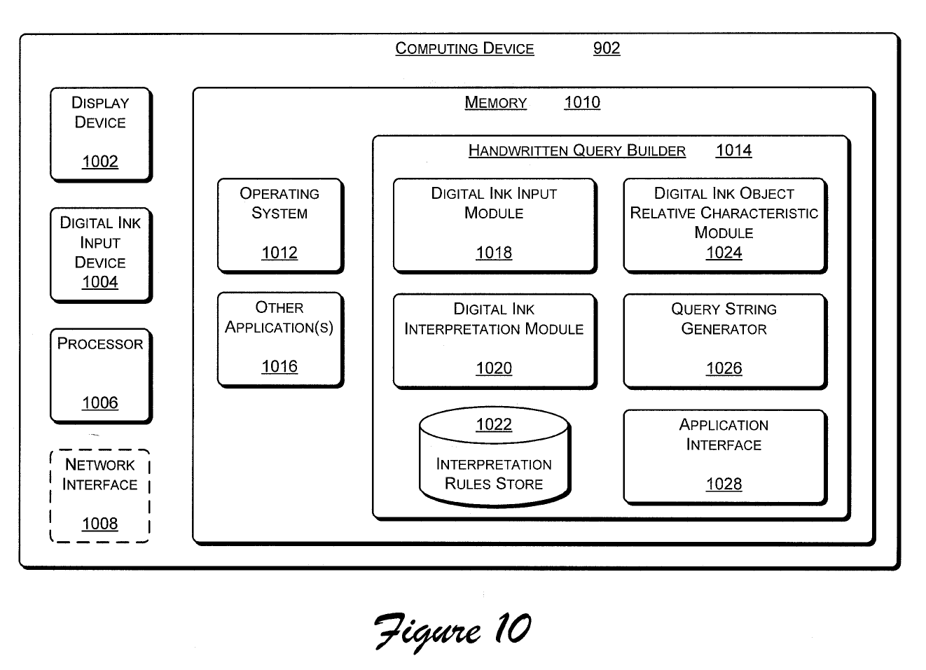

FIG. 10 illustrates select components of an exemplary computing device 902, which may include a display device 1002, a digital ink input device 1004, a processor 1006, optional network interface 1008, and memory 1010. Display device 1002 provides a mechanism by which a user can view data via computing device 902. Digital ink input device 1004 provides a mechanism by which a user can input digital ink objects to computing device 902. In an exemplary implementation, display device 1002 and digital ink input device 1004 may be implemented as a single screen, as in computing devices 902(1), 902(2), 902(3), and 902(4) shown in FIG. 9. Alternatively, display device 1002 and digital ink input device 1004 may be separate components as in computing device 902(5) shown in FIG. 9. Network interface 1008 enables computing device 902 to communicate with other computing devices, for example, over the Internet 910. Operating system 1012, handwritten query builder 1014, and one or more other applications 1016 are maintained in memory 1010 and executed on processor 1006.

Exemplary handwritten query builder 1014 includes digital ink input module 1018, digital ink interpretation module 1020, interpretation rules store 1022, digital ink object relative characteristic module 1024, query string generator 1026, and application interface 1028. Digital ink input module 1018 is configured to receive digital ink objects via digital ink input device 1004 Digital ink interpretation module 1020 is configured to interpret the received digital ink objects, converting the received objects to text, filtering rules, or other commands, for example, according to object interpretation rules maintained by interpretation rules store 1022. Digital ink object relative characteristic module 1024 is configured to determine the relative characteristics of the received digital ink objects. For example, characteristics of a particular digital ink object may include vertical position, horizontal position, line thickness, line color, and so on. Digital ink object relative characteristic module 1024 determines relationships between the received digital ink objects based on one or more of the determined characteristics. Query string generator 1026 is configured to generate a combination of a text string, one or more filters, and one or more query rules, that when combined, represent a query that can be used to retrieve data. Exemplary query string generator 1026 generates the query based on data processed by digital ink interpretation module 1020 and digital ink object relative characteristic module 1024.

Application interface 1028 provides a means by which handwritten query builder 1014 communications with one or more other applications 1016. For example, other applications 1016 may include a web browser application via which a user can enter a search string to search the Internet. The web browser application may be configured to communicate with handwritten query builder 1014 via application interface 1028 to enable a user to enter search string data via digital ink input device 1004.

Methods for implementing a handwritten query builder may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

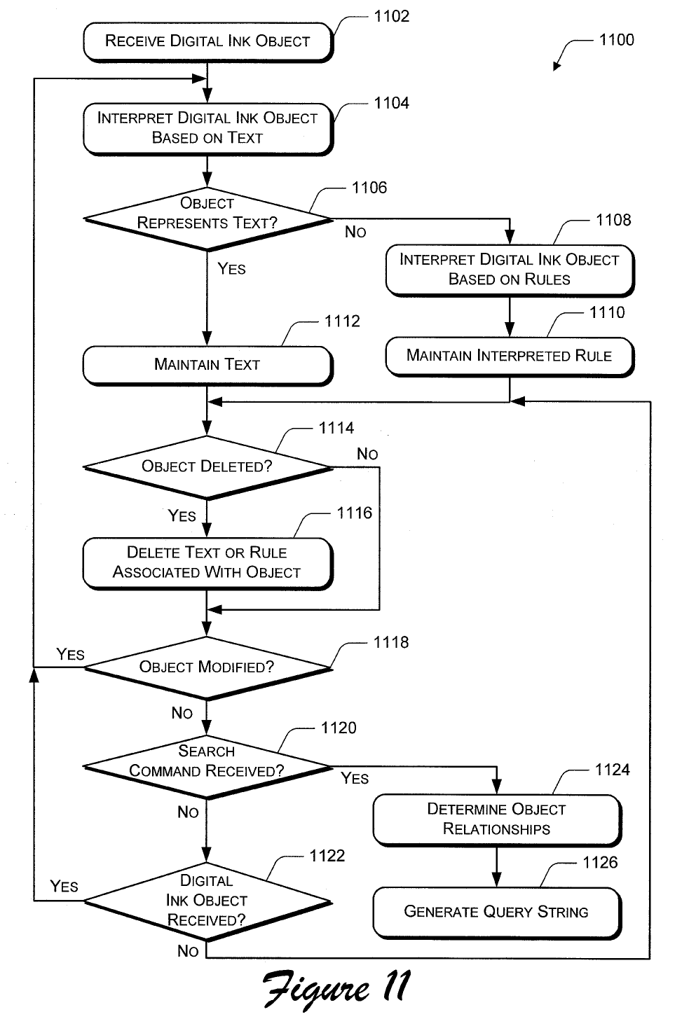

FIG. 11 illustrates an exemplary method 1100 for implementing a handwritten query builder. FIG. 11 is a specific example of a handwritten query builder implementation, and is not to be construed as a limitation. Furthermore, it is recognized that various embodiments may implement any combination of portions of the method illustrated in FIG. 11. The order in which the method is described is not intended to be construed as a limitation, and any number of the described method blocks can be combined in any order to implement the method. Furthermore, the method can be implemented in any suitable hardware, software, firmware, or combination thereof.

At block 1102, a digital ink object is received. For example, digital ink input module 1018 receives a digital ink object submitted by the user via digital ink input device 1004.

At block 1104, the digital ink object is interpreted as text. For example, digital ink interpretation module 1020 attempts to determine text represented by the digital ink object. At block 1106 it is determined whether or not the digital ink object represents text. For example, if digital ink interpretation module 1020 successfully determines a textual representation of the digital ink object, then it is determined that the digital ink object represents text.

If it is determined that the digital ink object does not represent text (the “No” branch from block 1106), then at block 1108 the digital ink object is interpreted based on rules. For example, digital ink interpretation module 1020 examines the digital ink object in light of rules maintained by interpretation rules store 1022 to determine an interpretation of the digital ink object. At block 1110, the rule or filter interpreted from the digital ink object is maintained. Processing then continues as described below with reference to block 1114.

If it is determined that the digital ink object represents text (the “Yes” branch from block 1106), then at block 1112, the textual interpretation of the digital ink object is maintained.

At block 1114, it is determined whether or not a digital object has been deleted. For example, digital ink module determines whether or not a user has initiated a delete command in association with a previously existing digital object. If it is determined that no digital object has been deleted (the “No” branch from block 1114), then processing continues as described below with reference to block 1118. On the other hand, if it is determined that a previously existing digital object has been deleted (the “Yes” branch from block 1114), then at block 1116, the text or rule interpretation currently being maintained in association with the deleted digital ink object is removed.

At block 1118 it is determined whether or not a digital ink object has been modified. For example, digital ink module determines whether or not a user has initiated a modification command (e.g., move, resize, color change, etc.) in association with an existing digital object. If it is determined that a digital object has been modified (the “Yes” branch from block 1118), then processing continues as described above with reference to block 1104, with the modified object as the current digital ink object.

On the other hand, if it is determined that no digital objects have been modified (the “No” branch from block 1118), then at block 1120, it is determined whether or not a search command has been received. For example, digital ink input module determines whether or not a user has selected a search button via a user interface.

If it is determined that a search command has not yet been received (the “No” branch from block 1120), then at block 1122, it is determined whether or not another digital ink object has been received. If no new digital ink objects have been received (the “No” branch from block 1122), then processing continues as described above with reference to block 1114. On the other hand, if a new digital ink object has been received (the “Yes” branch from block 1122), then processing continues as described above with reference to block 1104, with the new digital ink object as the current digital ink object being processed.

Referring back to block 1 120, if it is determined that a search command has been received (the “Yes” branch from block 1120), then at block 1124, relationships between existing digital ink objects are determined. For example, digital ink object relative characteristic module examines the relative locations, sizes, colors, line thickness, etc. of the digital ink objects, and determines an ordering of the digital ink objects based on the determined relative characteristics.

At block 1126, a query string is generated. For example, query string generator 1026 combines the maintained textual representations and the maintained rule-based object interpretations into a meaningful query string, with the ordering of the query terms based on the relative characteristics determined by digital ink object relative characteristic module 1024.

Although embodiments of a handwritten query builder have been described in language specific to structural features and/or methods, it is to be understood that the subject of the appended claims is not necessarily limited to the specific features or methods described. Rather, the specific features and methods are disclosed as exemplary implementations of a handwritten query builder.

1. A method implemented at least in part by a computing device, the method comprising:
identifying a plurality of objects, a first object of the plurality of objects comprising digital ink;
determining first and second keywords respectively represented by the first object and a second object of the plurality of objects; and
determining a sequence of the first and second keywords based on a two-dimensional arrangement of the first and second objects.

2. The method as recited in claim 1, wherein the first object comprises at least one of a handwritten word or a handwritten drawing.

3. The method as recited in claim 1, wherein the second object comprises at least one of a handwritten word, a handwritten drawing, or at least a portion of an image.

4. The method as recited in claim 1, wherein determining the sequence of the first and second keywords comprises analyzing a two-dimensional arrangement of the first and second objects to determine at least one of a vertical relationship between the first and second objects, or a horizontal relationship between the first and second objects.

5. The method as recited in claim 1, wherein determining the sequence of the first and second keywords comprises analyzing at least one of a relative height of the first and second objects, a relative line thickness of the first and second objects, or a relative ink color of the first and second objects

6. The method as recited in claim 1, further comprising: generating a query command based on an interpretation of one of the plurality of objects.

7. The method as recited in claim 6, wherein the query command comprises a filter command.

8. The method as recited in claim 6, wherein the one of the plurality of objects comprises at least a portion of an image.

9. The method as recited in claim 6, wherein the one of the plurality of objects comprises a handwritten drawing.

10. The method as recited in claim 1, wherein determining the sequence of the first and second keywords comprises:
determining a vertical relationship between the first and second objects;
in an event that the vertical relationship indicates that the first object is above the second object, determining the sequence such that the first keyword is before the second keyword; and
in an event that the vertical relationship indicates that the first and second objects are at substantially the same vertical position, determining the sequence of the first and second keywords based on a horizontal relationship between the first and second objects.

11. The method as recited in claim 1, further comprising:
identifying a demarcation associated with at least two of the plurality of objects;
creating a group entity comprising each of the at least two of the plurality of objects;
determining a sequence of the at least two of the plurality of objects based on a relationship of characteristics associated with each of the at least two of the plurality of objects;
determining a sequence of the group entity and at least one other of the plurality of objects based on a relationship of characteristics associated with the group entity and the at least one other of the plurality of objects.

12. The method as recited in claim 11, further comprising: generating a query string wherein:
the objects comprising the group entity are joined by an OR command; and
the group entity and the at least one other of the plurality of objects are joined by an AND command.

13. A system comprising:
a processor;
memory; and
a handwritten query builder maintained in the memory and executed on the processor, wherein the handwritten query builder is configured to generate a query string based, at least in part, on one or more digital ink objects.

14. The system as recited in claim 13, wherein the handwritten query builder is further configured to modify an ordering of terms in the query string based on a change in relative characteristics of at least two of the one or more digital ink objects.

15. The system as recited in claim 14, wherein the relative characteristics comprise at least one of a relative vertical position, a relative horizontal position, a relative height, a relative line thickness, or a relative line color.

16. The system as recited in claim 13, wherein the handwritten query builder comprises:
a digital ink input module to receive a plurality of objects, the plurality of objects comprising first and second digital ink objects;
a digital ink interpretation module to generate first and second textual representations of the first and second digital ink objects, respectively;
a digital ink object relative characteristic module to determine a relationship between the first and second digital ink objects; and
a query string generator to generate a query string that includes the first and second textual representations such that the order of the first and second textual representations is based on the relationship between the first and second digital ink objects.

17. The system as recited in claim 16, wherein the handwritten query builder further comprises an interpretation rules store to maintain rules for interpreting digital ink objects, wherein:
the digital ink interpretation module is further configured to generate a query command representation of a third digital ink object of the plurality of objects based on the rules maintained by interpretation rules store; and
the query string generator generates the query string to further include the query command representation of the third digital ink object.

18. One or more tangible computer-readable media comprising computer-readable instructions that, when executed, cause a computer system to:
identify a first keyword represented as a digital ink object;
identify a second keyword represented as a second digital ink object;
determine a relationship between the first digital ink object and the second digital object; and
generate, based on the determined relationship, a query string comprising the first and second keywords.

19. The one or more tangible computer-readable media as recited in claim 18, wherein the relationship is based on a two-dimensional location of the first object with respect to the second object.

20. The one or more tangible computer-readable media as recited in claim 18, wherein the relationship is based on a relative difference between a characteristic of the first object and the same characteristic of the second object.
